(19) United States
(12) Patent Application Publication
(10) Pub. No.: US 2007/0204808 A1
(43) Pub. Date: Sep. 6, 2007

(54) Cooled pet garment

(76) Inventor: Makoto Harada, Yokohama-shi (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(21) Appl. No.: 11/364,924

(22) Filed: Mar. 1, 2006

(51) Int. Cl. A01K 13/00

(52) U.S. Cl. 119/850

(57) ABSTRACT

A pet garment capable of cooling by extracting vaporization heat in a wide range and extracting vaporization heat for a relatively long period of time without using a special chemical. The present invention is a wearable pet garment. It comprises back and a breast piece. The back and breast are continuously formed as a piece. Between the garment back and the garment breast, a neck hole is opened to pass a head and neck of pet, and adhesive parts are constructed on both sides of the garment back and on both sides of the garment breast. The garment back and the garment breast are composed of a water permeable sheet in an untouched surface on the pet. They are composed of the waterproof sheet in a touched surface on pet. A water holding layer, composed of a water-containing material, is disposed between the water permeable sheet and the waterproof sheet.

### TECHNICAL FIELD

The present invention relates to a cooled garment for a pet walking on four legs, and particularly, for lowering a body temperature of dog being not good at controlling body temperature.

### BACKGROUND ART

Dogs as a representative of pet do not develop as a high perspiration function as human, we have to pay attention to our dogs when we walk them on paved roads particularly in summer. Additionally, dogs descended from northern lands have fine and soft hairs, therefore, some of them tend to become ill due to imperfect temperature controls in a summer season of Japan. Thus, a pet garment having pockets in which cooling materials are accommodated has been devised.

### INVENTION DISCLOSURE AND PROBLEMS TO BE SOLVED BY THE INVENTION

The foregoing conventional cooled pet garment is not considered particularly in waterproof, it is not useful for controlling the body temperature of dog because the accommodation of cooling materials is limited in some pockets. Moreover, it is necessary to purchase a special cooling material, which poses a problem of unnecessary expenses.

### MEANS TO SOLVE THE PROBLEMS

In order to solve the foregoing problems, a cooled pet garment according to the present invention is characterized in that a garment for wear by a pet walking on four legs comprising: back of pet garment and breast of pet garment, wherein the back of pet garment and the breast of pet garment are continuously formed as a piece and a neck hole is opened to pass a head and neck of pet in between the back of pet garment and the breast of pet garment; adhesive parts on both sides of the back of pet garment and on both sides of the breast of pet garment are constructed; and the back of pet garment and breast of pet garment are composed of a water permeable sheet in an untouched surface on pet and a waterproof sheet in a touched surface on pet, wherein a water-holding layer composed of a water-containing material is disposed between the water permeable sheet and the waterproof sheet.

### EFFECT OF THE INVENTION

The cooled pet garment of the present invention as described above affords the following effects:

(1) For a pet walking on four legs, its back and breast particularly necessary to cool can be cooled down by extraction of vaporization heat in a wide range.

(2) It is highly economical because of extraction of vaporization heat for a relatively long period of time only by being soaked in water like a normal tap water and squeezed lightly to hold water in a water-holding layer, not using special chemicals.

(3) A water-holding layer can not only hold water but also emit or impregnate liquids for destroying and protection from harmful insects. By doing this, the access of mosquito, flea and mite can be prevented, or the insects can de destroyed, therefore, it is effective during our taking pet for a walk particularly in summer.

### BEST MODE FOR CARRYING OUT THE INVENTION

The preferred embodiments of the present invention will be described below in detail with reference to the following drawings.

### EXAMPLES

1. Whole constitution. The present invention is a soft sheet-like garment for a pet walking on four legs, back of garment 1 and breast of garment 2 are continuously formed as a piece.

2. Back of garment 1. The back of garment 1 is a sheet-like body covering the back of a pet. Though a planar shape of the back of garment 1 differs almost similarly depending on a type of pet, body length and body shape, it constitutes an approximate T-shape in a planar development.

3. Breast of garment 2. The breast of garment 2 is a sheet-like body covering the breast of a pet. Though a planar shape of the breast of garment 2 also differs almost similarly depending on a type of pet, body length and body shape, it constitutes an approximate T-shape in a planar development. In one end of breast of garment 2, a curved notch 4 is formed to allow a pet to urinate easily and is to be a suitable shape for a male dog.

4. Neck hole 3. A neck hole 3 is opened to pass a head and neck of pet in between the back of garment 1 and the breast of garment 2. Around the neck hole 3, a long bag is equipped or formed as a piece. Inside the long bag, cord 5 for fastening is accommodated. The exposed end of the cord is passed through a lock member, and fastening is maintained with this lock member.

5. Adhesive part. Adhesive parts 6 on both sides of back of garment 1 and on both sides of breast of garment 2 are constructed. As the adhesive part 6, for example, a piece of commercially available adhesive member can be employed. The adhesive parts 6 are constructed so as to catch in the case of touching both pieces of which respective pieces of commercially available adhesive members are sewn on the inside of back of garment 1 and outside of breast of garment 2. When the back of garment 1 and breast of garment 2 are took apart by a certain force, the catch of both pieces is simply released. Once both the pieces are joined with the adhesive parts 6, unlike buttons, the adhesive joining cannot be parted or garment cannot be taken off even if pets exercise vigorously. Additionally, unlike a constitution of cord tying, there is no inconvenience such that cords are entwined on washing

6. Three-layer structure. The back of garment 1 and the breast of garment 2 are composed of at least three layers. Namely, the three layers are a water permeable sheet 7, a waterproof sheet 8 and a water-holding sheet 9. The water permeable sheet 7 and waterproof sheet 8 are at least sewed up in the periphery by a sawing machine to integrate. An alternative constitution by adhering each other to integrate and bordering with a sewing machine to reinforce the periphery can be adopted.

7. Water permeable sheet 7. The layer of untouched surface on pet is composed of a water permeable sheet 7. The water permeable sheet 7 is a sheet to take water in and readily evaporate the water that has been taken in. To achieve such functions, it is a sheet such as net or cloth with many small bores or a sheet with fine openings. The materials have flexibility exhibited by a material such as plastic fiber or cloth and natural fiber cloth, together with functions of water repellency and water penetration. For example, a cloth made of compound fibers such as nylon, polyester and acrylic can be employed. When the water permeable sheet 7 is a cloth-like material, it is possible to print colors and patterns thereon.

8. Waterproof sheet 8. The layer of touched surface on pet is composed of a waterproof sheet 8. The waterproof sheet 8 is a sheet-like material to prevent water from going out. The reason for adopting a sheet that prevents water from going out is not to wet the hairs of pet. The waterproof sheet 8 is also composed of a flexible material. For example, a sheet made of polyethylene, polyvinyl chloride, polypropylene and natural resins, etc., can be employed.

9. Water-holding layer 9. A water-holding sheet 9 is interposed across the almost whole surface between the water permeable sheet 7 and waterproof sheet 8, and integrated by sewing up or adhesion. The water-holding sheet 9 is composed of a material with water-containing ability and flexibility. As the water-holding sheet 9, the examples that can be used include a material with water-holding ability made of felt; a material with water-holding ability made of pile fabric or flexible knit; polymers with water-holding function; porous materials derived from polyvinyl alcohols as a starting material; sponges; water absorbing pulps, acrylic and rayon; and other known materials with water-holding ability. Further, specifically, compound materials of water absorbing rayon, water absorbing acrylic, and polyesters with a low melting point can be used. In comparison to common sponges, felts have higher hydrophilicity and quick-drying to extract vaporization heat efficiently. Therefore, when touching water, felts perform excellent water absorbing and water-holding abilities by capillary phenomena through very fine pores spread in all directions. An elastic water absorbing sheet including felt, by using a laminate seal of polyethylene being attached thereto, can further acquire a high water-holding function. By extracting heat through the evaporation of water absorbed and held, a cooling effect is performed.

10. Water-holding. The foregoing garment is soaked into water or ice water in containers to sufficiently contain water inside the water-holding 9. Afterward, it is lightly squeezed up to no dripping of water on taking it up.

11. Wear. In the foregoing steps, a garment holding water inside the water-holding layer 9 is worn by a pet. In this case, the water permeable sheet 7 side is to be touched on a pet. Next, a head and neck of pet is passed through the neck hole 3 and the position is fixed by tightening a cord around the neck hole 3. About the time, by employing adhesive tapes positioned on both sides of the back of garment 1 and breast of garment 2, both are integrated. As a result, the back and breast of the pet are covered with the back of garment 1 and breast of garment 2 accommodating the water-holding layer 9.

12. Cooling effect. When walking out in a state of back and breast being covered, water inside the water-holding layer 9 evaporates into air through the surface of water permeable sheet 7. On evaporation, extraction of vaporization heat lowers the temperature of the water-holding layer 9. The lowered temperature is conducted to the surface of body of pet through the waterproof sheet 8 which is inside, the pet can feel a couple of temperatures lower than an ambient temperature. Generally, water once penetrated remains for a half day, although depending on a material of water-holding layer 9, ambient temperature and strength of sunshine, and continues evaporating to remove a body temperature from the surface of a pet, and the cooling effect can be maintained.

13. Insect proof and insecticidal efficiency. When water being held in the water-holding layer 9, chemicals for destroying harmful insects dissolved into the water can prevent the access of mosquito, flea and mite. Alternatively, chemicals can be sprayed sometimes to impregnate thereto while taking pet for a walk. As the chemicals, for example, commercially available chemicals such as herb, lemongrass, geranium, citronella, eucalyptus, cypress and mint can be employed. In addition, as exterminators, commercially available chemicals such as phenotrin, allethrin and pyriproxifen can be employed.

### BRIEF DESCRIPTION OF THE DRAWINGS

FIG. 1 is a development of cooled pet garment in Examples according to the present invention.

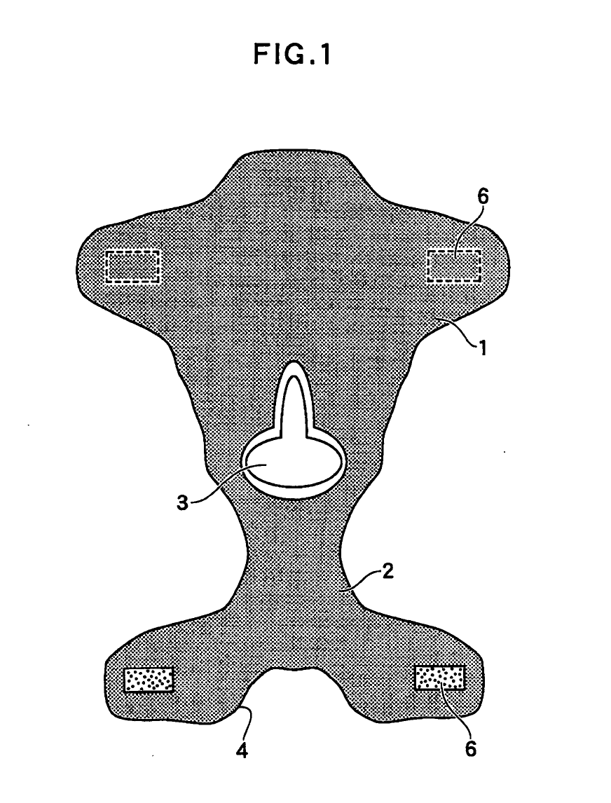

FIG. 2 is an explanatory drawing of state of wear by a pet.

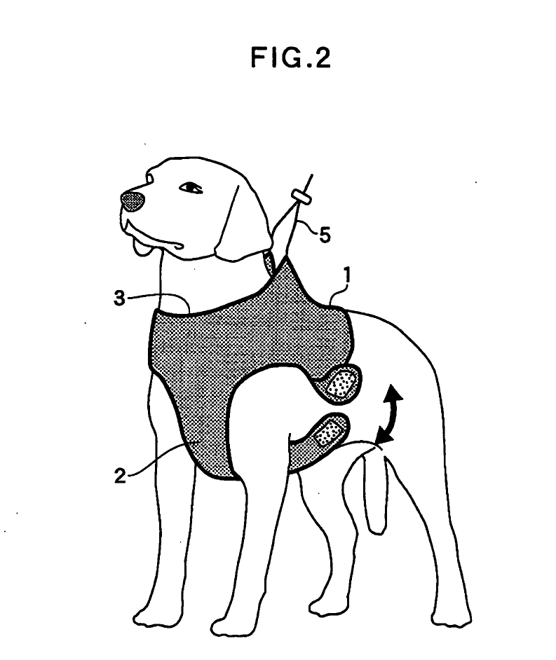

FIG. 3 is an explanatory drawing of tree-layer constitution in Examples.

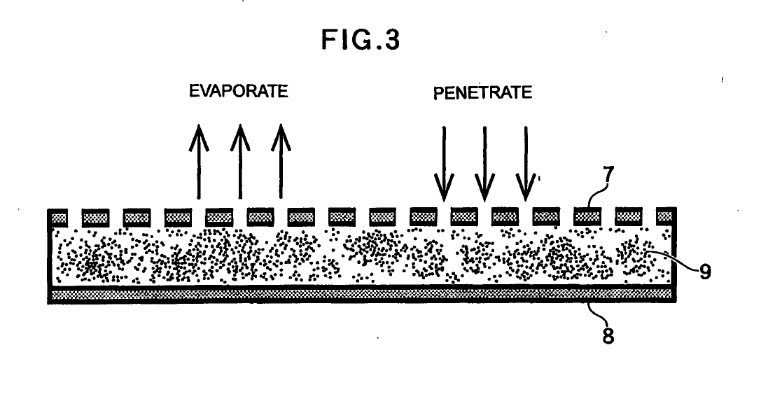

### DESCRIPTION OF NUMBER AND SYMBOL

1: Back of garment
2: Breast of garment
3: Neck hole
6: Adhesive part
7: Water permeable sheet
8: Waterproof sheet
9: Water-holding layer

What is claimed is:

1. A cooled pet garment for wear by a pet walking on four legs comprising:
a back of pet garment and a breast of said pet garment, wherein the back of the pet garment and the breast of the pet garment are continuously formed as a piece and a neck hole is opened to pass a head and a neck of said pet in between the back of pet garment and the breast of pet garment;
an adhesive part on both sides of the back of pet garment and on both sides of the breast of pet garment are constructed; and
the back of pet garment and breast of pet garment are composed of a water permeable sheet in an untouched surface on pet and a waterproof sheet in a touched surface on pet, wherein a water-holding layer composed of a water-containing material is disposed between the water permeable sheet and the waterproof sheet.

2. The cooled pet garment of claim 1 wherein the water-holding layer employs one of, or a combination of a polymer with water-holding function, a felt fabric, a pile fabric, a stretchy knit, water absorbing acrylic and water absorbing rayon.
